(19) United States
(12) Patent Application Publication
(10) Pub. No.: US 2006/0028744 A1
(43) Pub. Date: Feb. 9, 2006

(54) Supplemental convex mirror situated inside a vehicle

(76) Inventor: Mario Campion, Varennes (CA)

Correspondence Address: INVENTARIUM, Suite 1607, 4050 Rosemont Blvd, Montreal, QC, H1X 1M4, CA

(21) Appl. No.: 11/195,195

(22) Filed: Aug. 1, 2005

Related U.S. Application Data
(60) Provisional application No. 60/598,476, filed on Aug. 3, 2004.

(51) Int. Cl. G02B 7/182

(52) U.S. Cl. 359/871; 359/867

(57) ABSTRACT

A supplemental convex mirror situated inside a vehicle consists of a convex mirror enclosed within a frame, which is adjustable so that the optimal orientation can be achieved for whoever is driving the vehicle regardless of height. The mirror is situated inside the vehicle next to the exterior mirror where the car window usually ends. An optimal shape can be had which makes it easy to install when bought separately at an auto parts store. Alternatively, the mirror could come factory installed as an option or standard equipment on new vehicles.

This application claims priority based on provisional application 60/598,476 filed Aug. 3, 2004

### BACKGROUND OF THE INVENTION

1. Field of the Invention

This invention relates generally to mirrors but more particularly to a convex mirror situated inside a vehicle to increase safety for drivers.

2. Background

The prior art reveals several different types of convex mirrors created to eliminate blind spots. Indeed, a conventional rearview mirror can only reflect a percentage of what is behind a car and side mirrors also have limited angles of view. It is possible, by carefully adjusting the left and right side mirrors as well as the rearview mirror to view virtually everything through mirrors until peripheral vision or a slignt turning of one's head can catch whatever needs to be viewed but this involves three well adjusted mirrors. That is why convex mirrors have been developed. Some examples include:

U.S. Pat. No. 4,624,539 shows a portable mirror device for rear view observation in a motor vehicle or the like having a mirror device connected to an end of an adjustment arm by a ball-and-socket type joint, while an opposite end of the adjustment arm is swivally connected to a mounting arrangement comprised of a spring clip, having a pair of clip members connected by a spring member, the spring member biasing the clip members towards a position wherein holding ends of the clip members engage each other.

U.S. Pat. No. 4,895,435 shows an apparatus which is mounted on the sunshield visor on the interior of a vehicle to enable the driver to see, without shifting his vision, the complete rearward and driver side field of vision. The apparatus is an elongated, preferably convex, mirror mounted in a frame and frictionally engaged by a clasp to the sunshield visor. The clasp is resiliently connected to the frame to reduce vibration. A bracket connected to the frame has a manually manipulatable screw therein which permits adjustment of the mirror as desired by a particular driver for improvement of the field of vision. In another embodiment, the frame has a plurality of clasps for engagement of the sunshield visor and a mirror of increased elongation.

U.S. Pat. No. 5,235,469 shows a horizontal cut stepped mirror mounted to the pillars of an automobile to either side of the windscreen. Such mirrors may be mounted for adjustment or affixed directly to the pillar. Cushioning and mechanical adjustments may be used in mounting to the pillar for safety. The mirrors can be mounted inwardly and/or outwardly of the side window.

U.S. Pat. No. 6,315,419 shows a composite mirror adapted for use as an outside rearview mirror of a motor vehicle includes a main or primary viewing mirror and an auxiliary blindzone viewing mirror juxtaposed to expose the vehicle blindzone to the vehicle operator.

The problem with implementing convex mirrors in passenger cars in particular is that they can be viewed as cumbersome or difficult to install or both. There is therefore a need for a small easy to install convex mirror.

### SUMMARY OF THE INVENTION

In view of the foregoing disadvantages inherent in the known devices now present in the prior art, the present invention, which will be described subsequently in greater detail, is to provide objects which are:

It is a first object of this invention to provide for a supplemental convex mirror which can be installed inside a vehicle, close to the existing exterior mirrors.

It is a second object of this invention to provide for a supplemental convex mirror which can be adjusted on all axes.

It is a third object of this invention to provide for a supplemental convex mirror which can come preinstalled on vehicles.

In order to do so, the present invention consists of a convex mirror enclosed within a frame, which is adjustable so that the optimal orientation can be achieved for whoever is driving the vehicle regardless of height. The mirror is situated inside the vehicle next to the exterior mirror where the car window usually ends. An optimal shape can be had which makes it easy to install when bought separately at an auto parts store. Alternatively, the mirror could come factory installed as an option or standard equipment on new vehicles.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

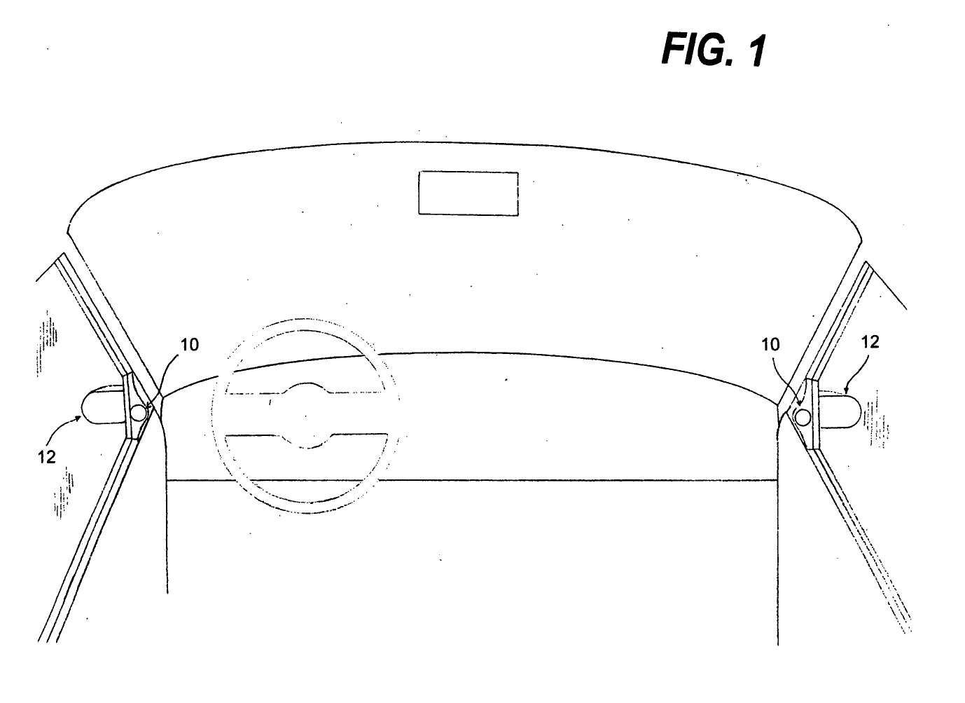

FIG. 1 Perspective view of a pair of convex mirrors in context inside a vehicle.

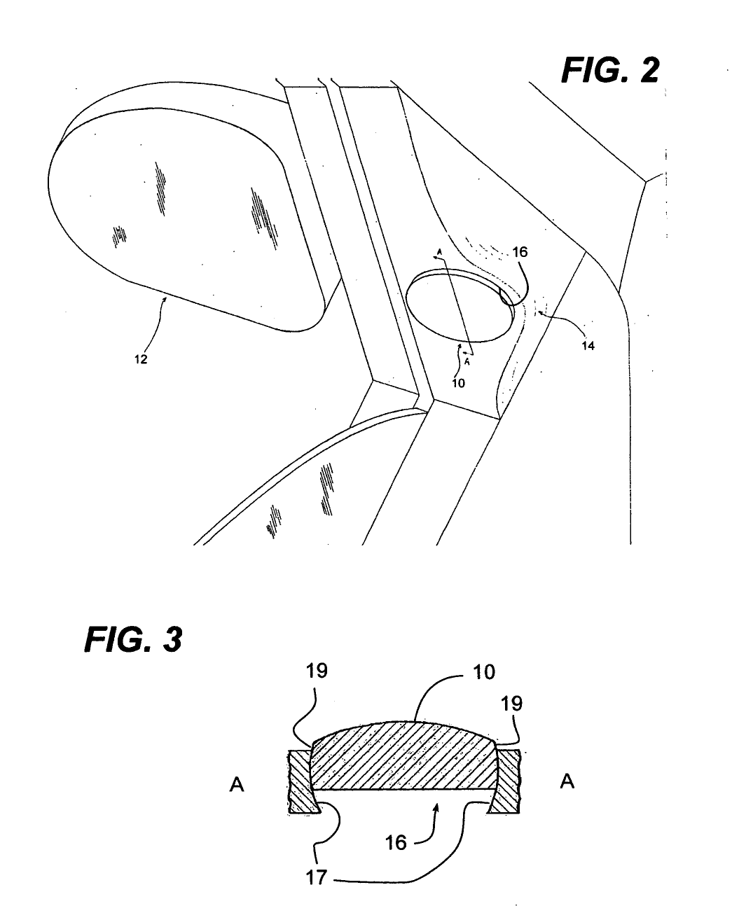

FIG. 2 Close up perspective view of the convex mirror.

FIG. 3 Cutaway side elevation of convex mirror along line A-A.

### DETAILED DESCRIPTION OF THE PREFERRED EMBODIMENT

FIG. 1 Two supplemental convex mirrors (10) are situated next to existing exterior mirrors (12).

FIG. 2 The supplemental convex mirror (10) is enclosed within a circular holder (16) which is part of a frame structure (14) which allows the supplemental convex mirror (10) to be oriented along many axes. The frame structure (14) is configured and sized to appropriately fit a vehicle's door at the window level.

FIG. 3 The sides (17) of the circular holder (16) are curved to match the curves of the perimeter (19) of the convex mirror (10) so as to allow its rotational movement.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A supplemental convex mirror enclosed within a frame structure configured and sized to appropriately fit a vehicle's door at the window level;
said convex mirror being adjustable within said frame;
said frame structure situated inside a vehicle proximal an existing exterior mirror said frame structure having an opening;
said convex mirror being held within a circular holder.

2. A supplemental convex mirror enclosed within a frame as in claim 1 wherein:
one said convex mirror being situated on the driver's side while a second said convex mirror being situated on the passenger side proximal an existing exterior mirror.
